(19) United States
(12) Patent Application Publication
(10) Pub. No.: US 2006/0193469 A1
(43) Pub. Date: Aug. 31, 2006

(54) Parallel plane rotation hinge for a portable device

(76) Inventor: Tony Kfoury, Lisle, IL (US)

Correspondence Address: GREER, BURNS & CRAIN, 300 S WACKER DR, 25TH FLOOR, CHICAGO, IL, 60606, US

(21) Appl. No.: 11/336,616

(22) Filed: Jan. 20, 2006

Related U.S. Application Data
(63) Continuation-in-part of application No. 11/149,458, filed on Jun. 8, 2005.
(60) Provisional application No. 60/578,085, filed on Jun. 8, 2004.

(51) Int. Cl. H04M 1/00

(52) U.S. Cl. 379/433.13

(57) ABSTRACT

Parallel plane rotation hinge for a portable device. The hinge includes a pin defining a rotational axis and a cam having an inner cam track and an outer cam track. A follower surrounding the pin is rotationally fixed and axially slidable with respect to the pin, and includes inner and outer follower lobes for respectively rotationally engaging the inner and outer cam tracks. A biasing member is disposed about the pin to bias the follower against the cam.

### PRIORITY CLAIM

This application is a continuation-in-part of U.S. patent application Ser. No. 11/149,458, which claims the benefit of U.S. Provisional Patent Application Ser. No. 60/578,085, filed Jun. 8, 2004, under 35 U.S.C. § 119.

### BACKGROUND OF THE INVENTION

The present invention relates generally to portable devices. The present invention relates more particularly to hinges for portable devices.

Portable devices with hinged connections provide many advantages and are popular. Flip-style portable devices, for example, are a very popular form for handsets and personal digital assistants. Generally, in flip-style devices, one part may be considered a main part and the other part a flip part. A hinged connection provides controlled relative movement between the flip part and the main part. In the traditional flip-style connections, a flip part and main part are connected at a hinge axis that is generally in the plane of one or both of the flip part and the main part (or in a plane parallel to one of the flip part and the main part). This creates a clamshell-style open and close feature.

Flip-style devices form a convenient shape, and such devices have proven to be aesthetically pleasing to a large segment of the consumer market. When closed, flip-style devices provide a small device footprint, making the storage of the device in a pocket, on a clip, in a holder, in a briefcase, in a purse, or a drawer, etc., very convenient.

A hinge used to form a hinged connection in a portable device is in a very demanding environment. Operational cycles are high frequency, meaning that users of hinged portable devices open and close the device frequently. In the example of a flip phone, a user commonly opens and closes the device with each use of the device. A hinge should also provide a smooth and controlled operation, and should be biased to remain in respective open and closed positions. There is considerable interest, however, in keeping the hinge as simple and as inexpensive as possible.

### SUMMARY OF THE INVENTION

Embodiments of the present invention provide a parallel plane rotation hinge for a portable device. The hinge includes a pin defining a rotational axis and a cam having an inner cam track and an outer cam track. A follower surrounding the pin is rotationally fixed and axially slidable with respect to the pin, and includes inner and outer follower lobes for respectively rotationally engaging the inner and outer cam tracks. A biasing member is disposed about the pin to bias the follower against the cam.

### BRIEF DESCRIPTION OF THE DRAWINGS

FIGS. 1A and 1B are perspective views of a parallel plane rotation hinge for a portable device, according to an embodiment of the present invention;

FIG. 2 is an exploded view of the hinge of FIGS. 1A and 1B;

FIG. 3 is a sectional view of the hinge of FIGS. 1A and 1B;

FIG. 4 is a perspective view of a bushing for the hinge of FIGS. 1A and 1B;

FIG. 5 is a perspective view of a cam for the hinge of FIGS. 1A and 1B;

FIGS. 6A and 6B are perspective views of the hinge of FIGS. 1A and 1B in a closed position;

FIG. 7 is a perspective view of the hinge of FIGS. 1A and 1B in a partially open position;

FIG. 8 is a perspective view of the hinge of FIGS. 1A and 1B in a fully open position;

FIGS. 9A and 9B are perspective views of the hinge of FIGS. 1A and 1B, showing a stop mechanism for stopping rotation at 180° in respective directions;

FIG. 10 is a perspective view of a portable device for use with a hinge according to another embodiment of the present invention;

FIG. 11 is a perspective view of a cam for an alternative hinge;

FIG. 12 is a perspective view of an alternative hinge and a stop mechanism, according to an alternative embodiment of the present invention;

FIG. 13 is a perspective view of the alternative hinge of FIG. 12 in a fully open position, showing a stop mechanism;

FIGS. 14A and 14B are perspective top and bottom views, respectively, showing assembly of the hinge of FIG. 12 into the portable device of FIG. 10;

FIG. 15 is a perspective view of a hinge according to another embodiment of the present invention;

FIG. 16 is an exploded view of the hinge of FIG. 15;

FIG. 17A is a perspective view of a combined pin and cover bracket, according to an embodiment of the present invention;

FIG. 17B is a perspective view of an assembled hinge having the combined pin and cover bracket of FIG. 17A;

FIG. 18 is a sectional view of the hinge of FIG. 15;

FIG. 19 is a perspective view showing a pin, biasing member, and follower;

FIG. 20A is a perspective view of a follower;

FIG. 20B is a perspective view of a pin;

FIG. 21 is a perspective view of a hinge according to an alternative embodiment of the present invention;

FIG. 22 is an exploded view of the hinge of FIG. 21;

FIG. 23 is a sectional view of the hinge of FIG. 21;

FIG. 24A is a perspective view showing engagement of a pin and follower;

FIG. 24B is a perspective view of a pin;

FIG. 25 is a partial perspective view of a cam having a single cam track; and

FIG. 26 is a perspective view showing a method for placing a hinge into a handheld device, according to embodiments of the present invention.

### DETAILED DESCRIPTION

Preferred embodiments of the present invention provide a parallel plane rotation hinge for a portable device. As an alternative to traditional flip-style devices, in embodiments of the present invention, the hinge includes a rotational axis that, when the hinge is assembled into a portable device, preferably is generally perpendicular to the main part and the flip part, so that the flip part rotates both in clockwise and anti-clockwise directions via the hinge in a plane parallel to the plane of the main part. This provides a user-pleasing and unique operation.

Parallel plane rotational hinges provide an alternative to clamshell style handsets that is robust and stylish. However, preferred hinges according to the present invention also allow a portable device to retain the compact size and other desirable features of clamshell style handset openings. Preferred hinges further provide a smooth, controlled operation for opening and closing a portable device.

Preferably, to reduce cost, hinges in preferred embodiments are made from a relatively small number of parts. Further, hinges in preferred embodiments of the invention are self-contained, and they may be partially or fully assembled separately from a portable device into which the hinge will be inserted.

Preferred embodiments of the invention permit manual opening or self-opening (open-assist) to 180 degrees in either direction. The self-opening hinges may include button activation for convenient opening of a portable device.

Generally, parallel plane rotation hinges according to preferred embodiments of the present invention include a pin defining a rotational axis and a cam having an inner cam track and an outer cam track. A bushing is rotationally fixed and axially slidable with respect to the pin, and includes inner and outer followers for respectively rotationally engaging the inner and outer cam tracks. A biasing member disposed about the pin biases the bushing against the cam. The biasing member, for example, may provide smoother and more controlled movement for the hinge, and in particular embodiments, may provide a self-opening feature.

Preferred hinges are self-contained. A locking member may be provided for engaging an end of the pin to hold the cam axially. This allows a preferred hinge to be pre-assembled for insertion into a portable device.

The hinge may further include a stop slidable along a track and disposed within a rotational path of a part of the bushing. In this way, the bushing may engage the stop as it rotates. Further relative rotation of the bushing slides the stop until the stop engages an inner surface at either end of the track. Such engagement prevents further sliding of the stop and further rotation of the bushing. This prevents over-rotation of preferred embodiments of the hinge.

Particular embodiments of the hinge provide an interface between the inner and outer cam tracks and the inner and outer followers to respectively define a bias position. An exemplary bias position may resist relative rotation of the bushing (for example, providing initial resistance to opening the portable device). Alternatively, the cam may be configured for making the hinge unstable at a closing position (for example, providing an open-assist hinge). In the latter type of embodiment, a stop or stops may be provided for selectively and removably engaging a part of the bushing to inhibit rotation. A mechanism, such as a button and/or a lever, may be provided for moving the stop to allow relative rotation (for example, button activation for allowing opening of a portable device).

According to other embodiments of the present invention, a parallel plane rotation hinge includes a pin defining a rotational axis and a cam having an inner cam track and an outer cam track. A follower is rotationally fixed and axially slidable with respect to the pin, and includes inner and outer follower lobes for respectively rotationally engaging the inner and outer cam tracks. A biasing member disposed about the pin biases the follower against the cam.

In still other embodiments of the present invention, a parallel plane rotation hinge includes a pin defining a rotational axis and a cam having a cam track. The pin includes a pair of diametrically opposed outer surfaces extending parallel to the rotational axis. A follower surrounds the pin and includes a pair of diametrically opposed inner surfaces extending parallel to the rotational axis and slidingly engaging the pair of outer surfaces, so that the follower is rotationally fixed and axially slidable with respect to the pin. The follower includes a follower lobe for rotationally engaging the cam track. A biasing member disposed about the pin biases the follower against the cam.

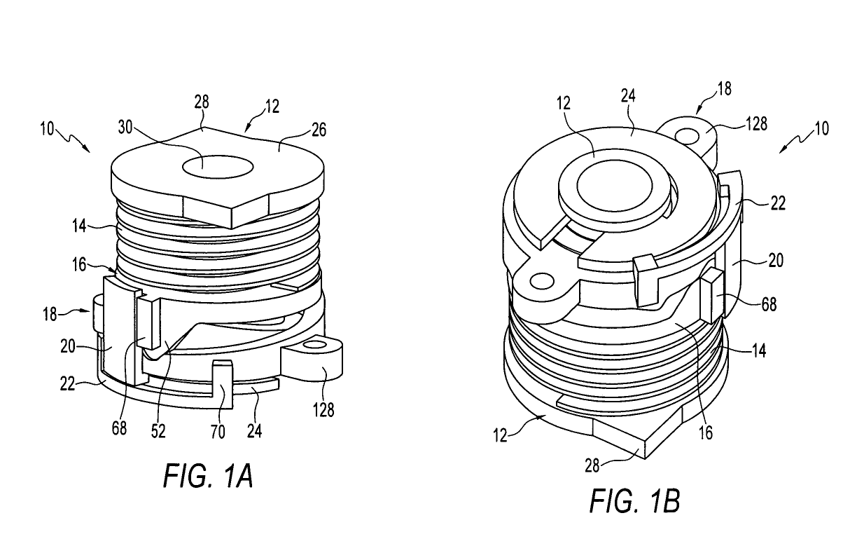

Referring now to the drawings, FIGS. 1A and 1B show top and bottom views, respectively, of a parallel plane rotation hinge 10 for use with a portable device (such as a handheld device) in a preferred embodiment. As shown in FIGS. 1A and 1B, the preferred hinge 10 is modular or self-contained, and can be preassembled for later insertion into the handheld device. As used here, the terms “top” and “bottom” regarding the hinge 10 refer to the orientations of FIGS. 1A and 1B respectively and are not intended to limit the invention to a particular orientation.

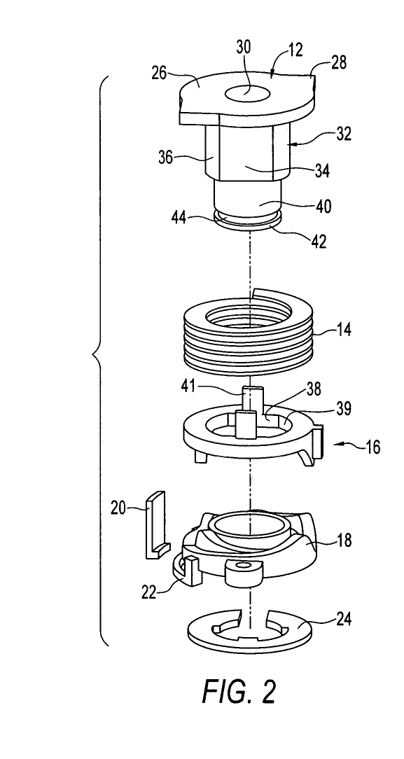

Referring also to FIG. 2, the exemplary hinge 10 shown generally includes a pin-follower 12, a biasing member 14 illustrated in this embodiment as a coil spring with a flat cross-section, a bushing-follower 16 engaged with the pin-follower for co-rotational movement, a cam 18 engaged with the bushing-follower, a sliding stop 20 engaged with the cam and with a track 22 mounted to the cam, and an external lock ring 24 for engaging the pin-follower and maintaining assembly of the hinge.

The pin-follower 12, preferably made of a metal such as alloy steel with plating, defines a rotational axis. This rotational axis, when the hinge 10 is installed into a portable device, preferably is generally perpendicular to the planes of the flip part and the main part of a portable device. In a preferred embodiment, an upper end 26 of the pin-follower 12 includes a pair of projections 28 for engaging a flip part (e.g., cover) of the portable device, so that the flip part rotates as the pin-follower rotates with respect to the cam 18. In this way, the flip part is able to slide along a parallel direction with respect to the main part. The pin-follower 12 may engage the flip part of the portable device in any suitable manner for allowing the flip part to rotate with the pin-follower.

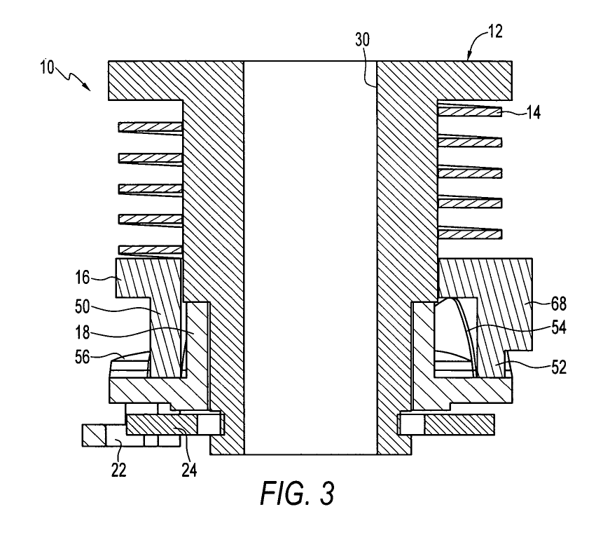

Referring now to FIGS. 1A, 1B, 2, and 3, the pin-follower 12 preferably includes an opening 30 through which a cable harness or twisted flex cable may be inserted for electrically connecting the flip part and the main part of the handheld device. As most clearly shown in FIG. 2, the pin-follower 12 has an outer engaging surface 32, which includes a pair of opposing flat surfaces 34 and a pair of opposing round surfaces 36. The flat surfaces 34 engage inner flat surfaces 38 of the bushing-follower 16, and the rounded surfaces 36 engage inner round surfaces 39 of the bushing-follower. In this way, the pin-follower 12 is rotationally fixed but axially slidable with respect to the bushing-follower 16. A pair of slide alignment ribs 41 extends axially from the bushing-follower 16 for aligning axial movement of the pin-follower 12 relative to the bushing-follower.

The pin-follower 12 further includes an inner extension 40, which preferably extends through a center of the cam 18, and terminates in an end 42 having a groove 44. The groove 44 engages the external lock ring 24 when the hinge 10 is assembled. This holds the cam 18 axially, thus maintaining assembly of the hinge 10, and further allows the hinge to be pre-assembled before insertion into a portable device. The lock ring 24 is preferably made of a metal such as carbon steel.

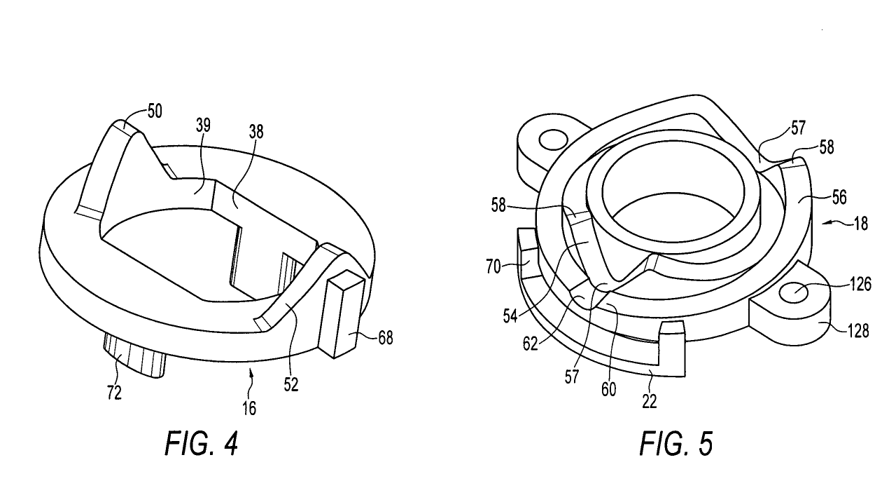

Referring now to FIGS. 4 and 5, the bushing-follower 16, also preferably made of a metal such as alloy steel with plating, includes a radially inner follower 50 and a radially outer follower 52, for respectively rotationally engaging concentric inner and outer cam tracks 54 and 56 of the cam 18. Use of the inner and outer followers 50, 52 and cam tracks 54, 56 in a preferred embodiment allow balanced forces for relative rotation of the bushing-follower 16, and they further provide rotation in either direction up to 180 degrees (for example) between a closed position and an open position. The cam 18 preferably is made of a metal such as alloy steel with plating.

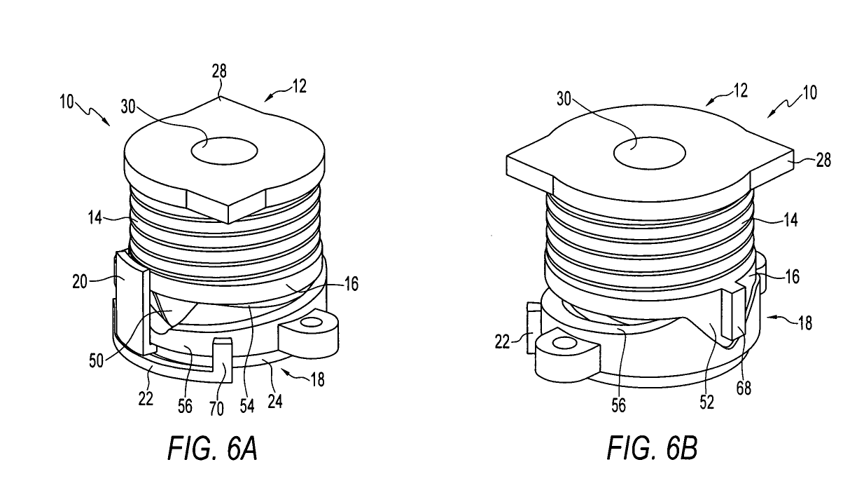

As shown in FIG. 5, an interface is provided between the inner and outer cam tracks 54 and 56 and the inner and outer followers 50, 52 to respectively define a bias position resisting relative rotation of the bushing-follower 16, providing a manual opening hinge. For example, the cam tracks 54, 56 each include a profile having a lower initial area 57 where the followers 50, 52 are initially disposed (a closed position, as shown in FIGS. 6A and 6B), a peak 58, and a shallow area 60 that is 180 degrees away from the initial area (open position). A small detent 62 is provided in the shallow area to retain a position of the followers 50, 52 in the open position.

The biasing member 14 is disposed about the pin-follower 12 and preferably about the ribs 41 (providing a spring stop), and biases the bushing-follower 16 against the cam 18. The biasing member 14, which in a preferred embodiment is a coil spring having a flat cross-section to provide minimal hinge height, provides resistance to opening and closing the hinge 10, and preferably provides a controlled, smooth movement for operation of the hinge. Round wire may also be used for the biasing member 14. Preferably, the biasing member 14 is made of a metal, for example, carbon steel.

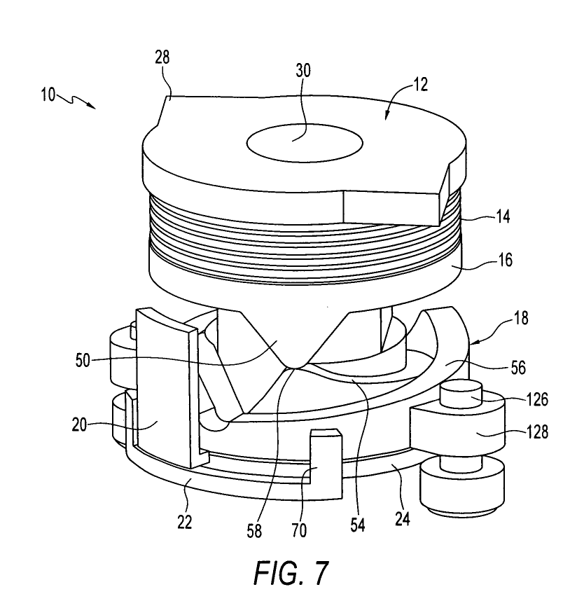

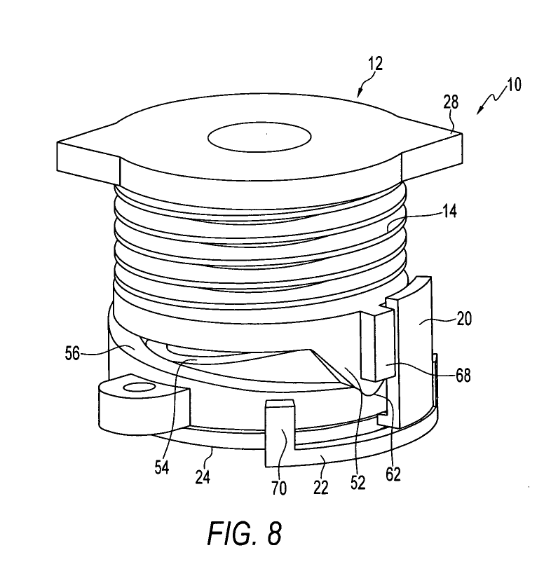

In the position shown in FIG. 7, the pin-follower 12 and the bushing-follower 16 are rotated slightly in the clockwise direction such that the followers 50, 52 (e.g., follower lobes) engage the peaks 58 of the cam tracks 54, 56 respectively. At this position, the biasing member 14 preferably is at its maximum spring force and the cam followers 50, 52 are at maximum travel. FIG. 8 shows the hinge 10 at a fully opened position. In this position, the followers 50, 52 preferably are both engaged in the detent 62 at the shallow area 60 of the inner and outer cam tracks 54, 56.

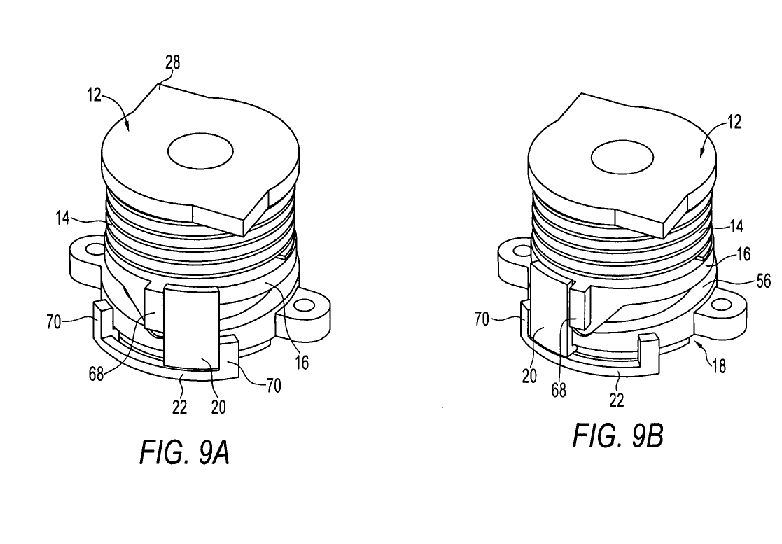

As also shown in FIG. 8 and FIGS. 9A and 9B, the bushing-follower 16 engages the stop 20 via a stop rib 68, which is disposed on the outer follower 52 of the bushing-follower 16, to prevent over-rotation of the hinge 10. The stop 20, which may be made, for example, of injection-molded acetal, is slidable along the track 22 and disposed within the rotational path of the stop rib 68. The track 22 is fixed relative to the cam 18, and defines an arc concentric with the inner cam track 54 and 56. In a preferred embodiment, the track 22 is formed with the cam 18 or mounted to the cam and more preferably cooperates with the cam 18 so that a part of the stop 20 slides along the track between the track and the cam. In this way, the stop 20 can easily be assembled into the modular hinge 10. Ends 70, and more particularly opposing inner surfaces of the ends 70, define the track. In other words, the ends 70 define the maximum travel path of the stop 20 in either rotational direction.

In operation, as the bushing-follower 16 rotates in either direction, the stop rib 68 engages the stop 20. The stop 20 slides along the track 22, pushed along by the stop rib 68 as it rotates relative to the cam 18, until the stop engages an end 70. At this point, the stop 20 is held against rotation, and thus the stop rib 68 is also held against rotation. This stops relative rotation of the bushing-follower 16 at 180 degrees (in a preferred embodiment) in either direction, and prevents over-rotation of the hinge.

For example, as shown in FIG. 9A, as the bushing-follower 16 is rotated in a counterclockwise direction, the stop rib 68 engages the stop 20 from its left side, causing the stop to slide along the track 22 until the stop engages the end 70, and thus the stop is restricted from further movement. Engagement of the stop rib 68 with the stop 20 thus prevents further relative rotation by the bushing-follower 16 and the pin-follower 12, along with the flip part preferably engaged with the pin-follower. Similarly, as shown in FIG. 9B, as the bushing-follower 16 is rotated in a clockwise direction, the stop rib 68 engages the stop 20 from its right side and slides the stop along the track 22 until the stop engages the end 70. At this point, the bushing-follower 16 and the pin-follower 12 are inhibited from further rotation relative to the cam 18. Thus, over-rotation of the hinge is prevented.

Accordingly, the preferred hinge 10 provides a modular, self-contained assembly, a preferably small overall volume, and flexibility for mounting to a housing of a portable device. In preferred embodiments, a small number of parts having preferably small sizes are required, assembly can made simple, and one or more of the parts can be standardized, such as the biasing member 14 and the lock ring 24. The hinge 10 can be configured as needed to adjust a required opening torque, resistance, hinge performance, etc.

Though the hinge 10 may be designed for manual actuation, in an alternative embodiment, a hinge may instead be provided with an open-assist feature. In such a hinge, for example, the cam tracks may be configured to make the hinge unstable in the closed position. Further, the hinge may be selectively activated to move a handheld device into an open position, for example, using button activation.

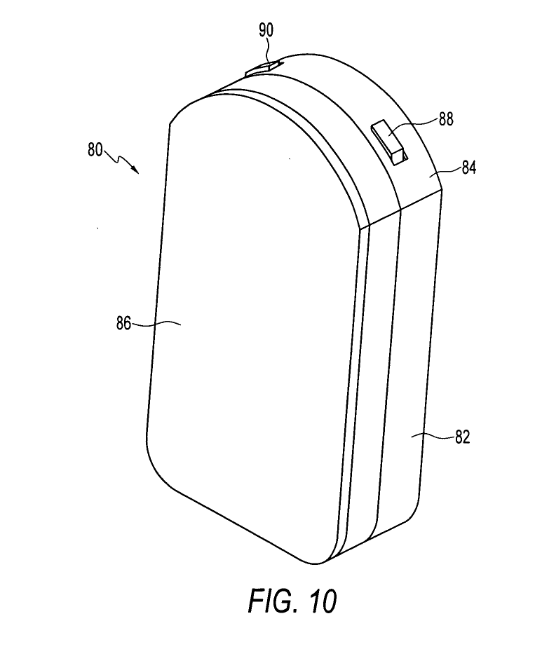

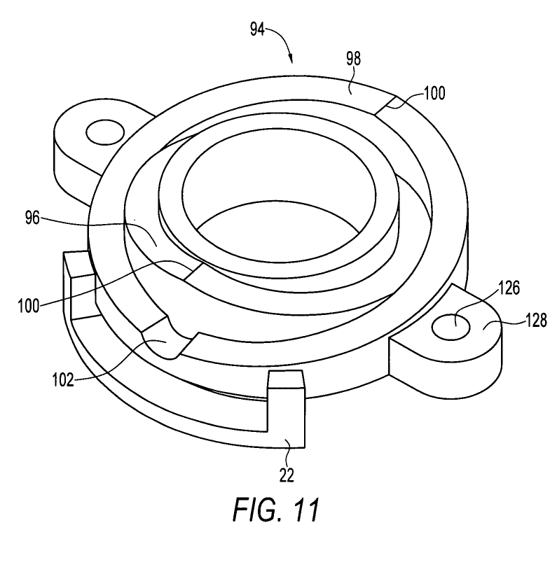

As shown in FIG. 10, for example, a handheld device 80 includes a housing 82 having a main part 84 and a flip part 86. The main part 84 includes a pair of right and left buttons 88, 90 for allowing rotation of an alternative hinge. In the portable device shown in FIG. 10, the buttons 88, 90 are placed on top of the device 80 (as oriented in FIG. 10), which may be preferable in particular instances to minimize their size and/or for ergonomic benefits, for example. However, it is contemplated that the buttons 88, 90 may be positioned or configured in ways other than that shown in FIG. 10. A similar portable device as the handheld device 80 may be used with the manual open hinge 10, though the buttons 88, 90 may be omitted.

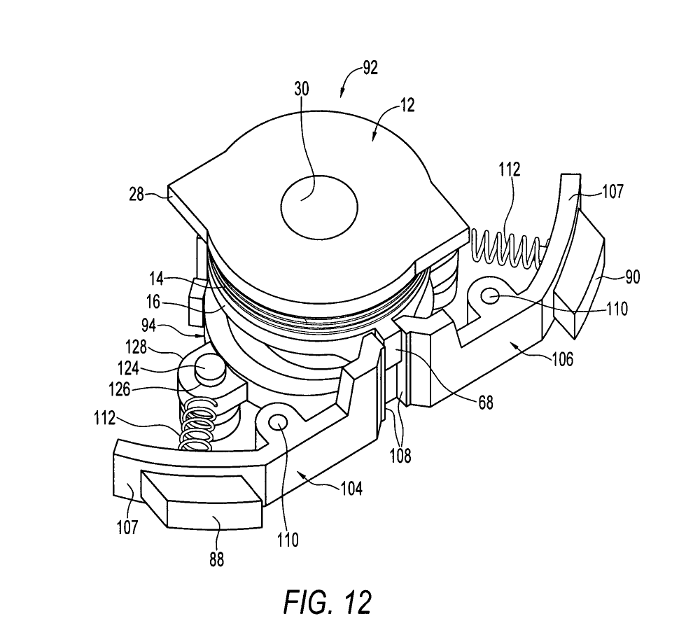

According to an alternative embodiment, and referring to FIGS. 11 and 12, a preferred open-assist hinge 92 is provided that is biased toward an opened position. Engaging the buttons 88, 90 allows the hinge 92 to provide relative rotation in either the clockwise or counterclockwise direction. In an exemplary hinge 92, the pin-follower 12, the bushing-follower 16, the stop 20, the track 22, and the lock ring 24 may be the same or similar to that used in the manual rotation hinge 10. However, in the exemplary open-assist hinge 92, a cam is provided for making the hinge unstable in a closed position.

For example, as shown in FIG. 11, cam 94 includes inner and outer tracks 96, 98, each having a profile including a ramp from a peak 100 at a closed position to a small detent 102 at an open position. As with the manual open hinge 10, use of concentric inner and outer tracks 96, 98 preferably provides balanced movement and 180 degree rotation in either the clockwise or counterclockwise direction. However, as opposed to the cam 18 in the manual open hinge 10, the cam 94 provides an open-assist feature by making the hinge unstable in the closed position.

As shown in FIG. 12, for example, the buttons 88, 90 are part of (or alternatively may be engaged with) a mechanism for selectively opening the handheld device 80 in either the clockwise or the counterclockwise direction. Preferably, the mechanism includes levers 104, 106, each of which include the button 88, 90 generally at one end and an inner engaging surface 108 at an opposing end.

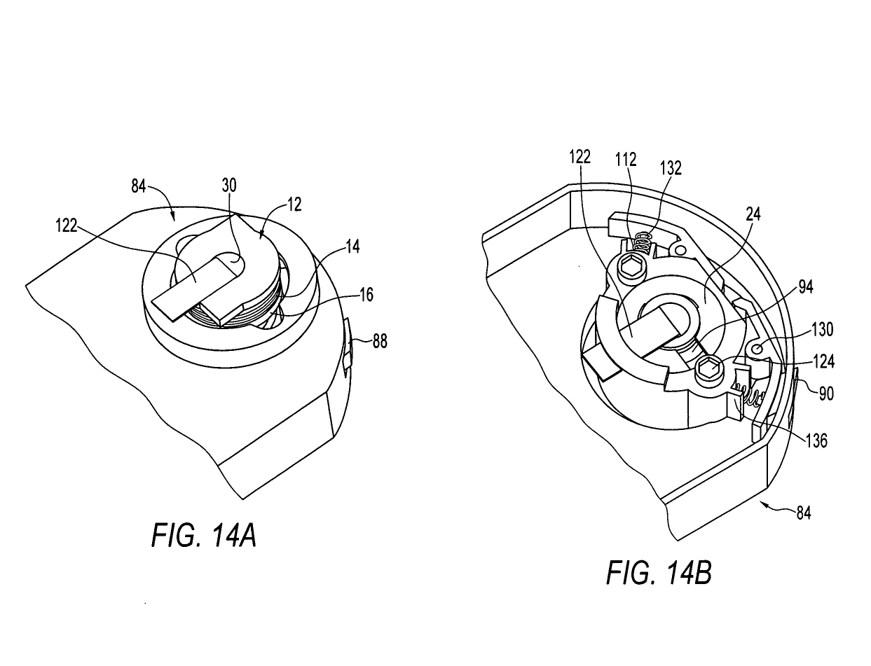

The preferably molded plastic levers 104, 106 are pivotally connected, for example, to the main part 84 of the portable device 80 (see FIG. 14B) via rotation points/fulcrums 110. The buttons 88, 90 are disposed at one end 107, and inner surfaces 108 are disposed at the opposing end. To inhibit relative rotation of the bushing-follower 16, the inner surfaces 108 are removably disposed within both a clockwise and a counter-clockwise rotational path of the stop rib 68. Biasing members such as coil springs 112 bias the buttons 88, 90 outward (for example, to the position shown in FIG. 12), and due to the levers 104, 106 the springs hold the inner surfaces 108 in engagement with the stop rib 68. Selective actuation of either button 88, 90 moves one of the inner surfaces 108 out of the relative rotational path of the stop rib 68, allowing relative rotation of the bushing-follower 16 and thus the pin-follower 12.

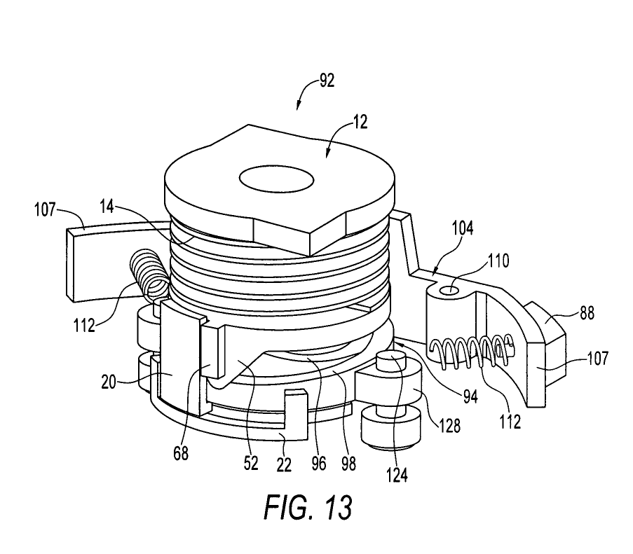

For example, referring again to FIG. 10, pushing the right button 88 causes the flip part (cover) 86 to rotate in the clockwise direction, towards the left. By contrast, pushing the left button 90 causes the flip part 86 to rotate in the counterclockwise direction, towards the right. FIG. 13 shows the hinge 92 in the fully open (180 degree) position. As shown, the stop 20 prevents over-rotation, as with the operation of the manual open hinge 10.

FIGS. 14A and 14B illustrate an exemplary assembly method of the hinge 92 into the handheld device 80. After pre-assembly of the hinge 92 and insertion of the hinge into the main part 84 of the handheld device 80, a cable 122 may be extended through the opening 30, and screws 124 engage threaded openings 126 within an ear 128 of the cam 94. The screws 124 lock the assembled hinge 92 into the main part 84. The levers 104, 106 including buttons 88, 90 may be slid into place, and the fulcrums 110 may be pivotally engaged to the main part 84 via bolts 130, for example. The biasing members 112 may be disposed about bolts 132 mounted to the outer ends 107 of the levers 104, 106 at one end and engaged with the main part 84 at the opposing end. Guides 136 may be provided in the main part 84 to prevent slippage of the biasing members 112 with respect to the levers 104, 106 and the main part 84.

To complete assembly, the projections 28 may be locked into the flip part 86 to provide co-rotation, and may be otherwise connected to the flip part 86 in a suitable manner. In this exemplary assembly method, the hinge 92 may be assembled independently of the main part 84 and then inserted into the main part 84 for providing controlled and/or assisted opening of the flip part 86 with respect to the main part 84. Assembly of the hinge 10 is similar to that of hinge 92, except the levers 104, 106 and the biasing members 112 may be omitted.

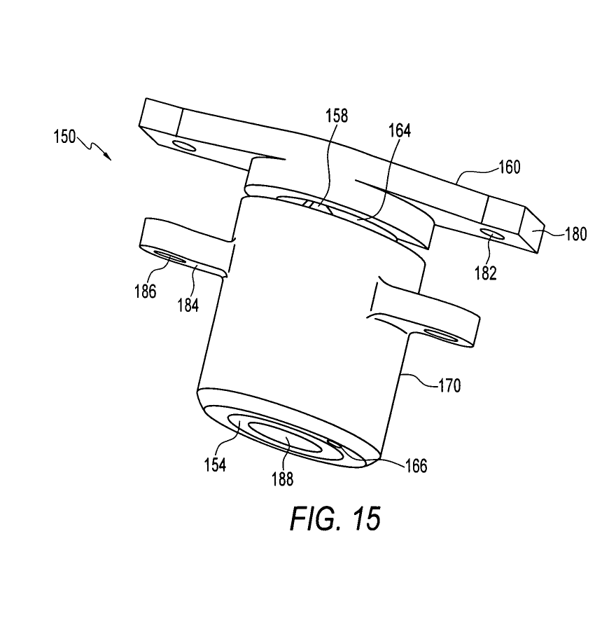

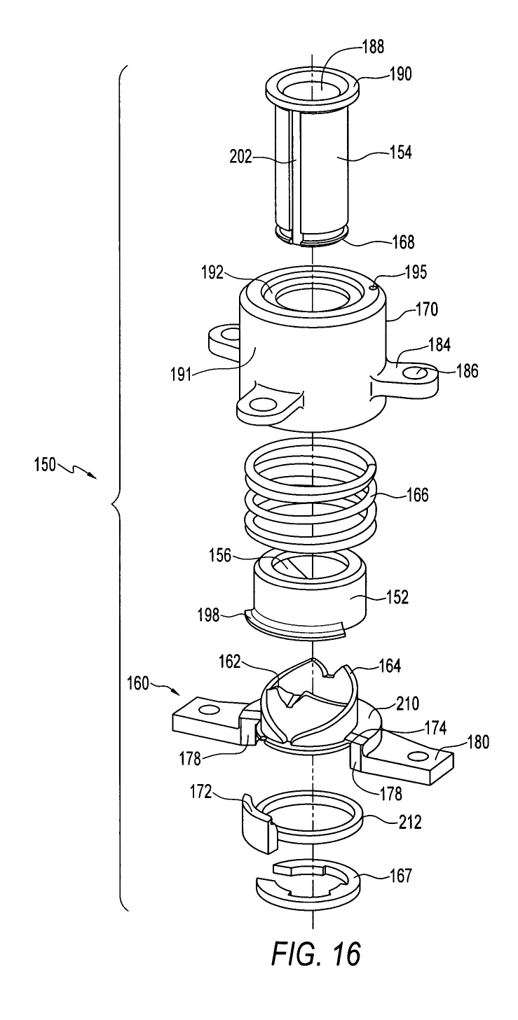

FIGS. 15-20 illustrate a self-contained, parallel plane rotation hinge 150 including a follower 152 (see FIG. 16) that is slidably engaged with but rotationally fixed to a pin 154. The pin 154 defines a rotational axis for the hinge 150. The follower 152, rotationally fixed and axially slidable with respect to the pin 154, includes radially inner and outer follower lobes 156, 158. A cam 160 having inner and outer cam tracks 162, 164 engages the follower 152 by the cam tracks respectively engaging the inner and outer follower lobes 156, 158. A biasing member 166 biases the inner and outer follower lobes 156, 158 against the inner and outer cam tracks 162, 164, so that the follower 152 (and thus the pin 154) and the cam 160 rotate with respect to one another. A locking member 167 engages a groove at an end 168 of an inner extension of the pin 154 to hold the cam axially and secure assembly of the complete hinge 150.

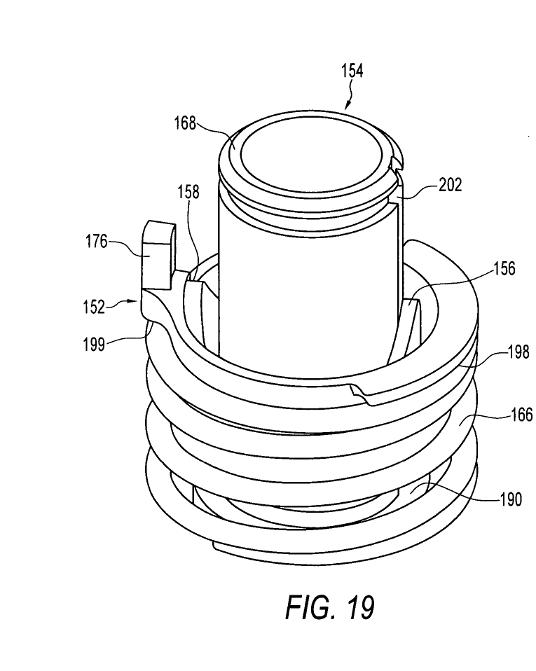

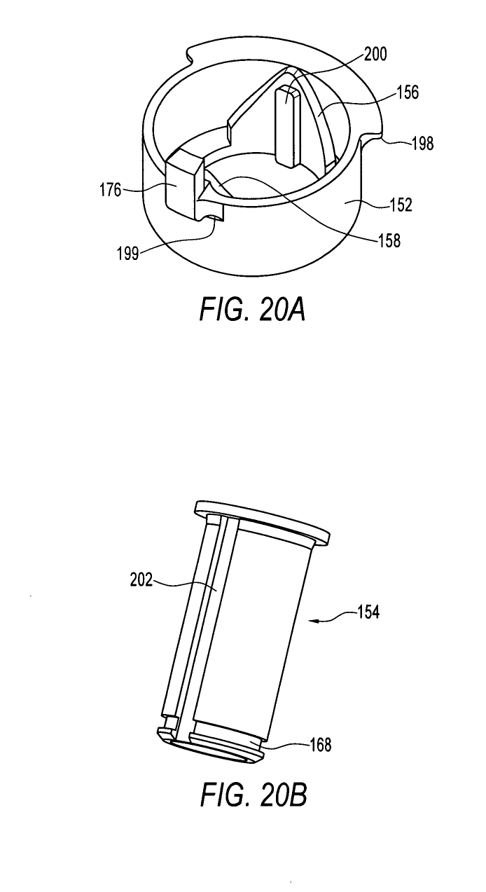

In the embodiment shown in FIGS. 15-20, a bracket cover 170 that is fixed with respect to the pin 154, and more preferably that is formed as a single piece with the pin, engages either a main part or a flip part of a handheld device. The cam 160 engages the part of the handheld device not engaged by the bracket cover 170. Rotation of the follower 152 with respect to the cam 160 causes rotation of the flip part with respect to the main part. To prevent over-rotation of the hinge 150, a sliding stop 172 is rotationally engaged with an annular surface 174 formed in the cam 160. When a stop rib 176 (see FIGS. 19 and 20A) of the rotating follower 152 engages the sliding stop 172, the stop rotates until it is inhibited from further rotation by a surface 178 of the cam.

Referring to FIG. 15, showing an assembled hinge 150, the bracket cover 170 in combination with the cam 160 generally encloses the hinge. As shown, the preferred hinge 150 is modular and self-contained, and can be pre-assembled before inserting into a handheld device. Particular features of the preferred hinge 150 allow the hinge to maintain a small height and diameter, thus consuming a relatively small amount of space within a handheld device.

In general operation, the bracket cover 170 rotates with respect to the cam 160 (or vice versa) to provide rotation of a flip part of the handheld device with respect to a main part. For connecting to the handheld device, the cam 160 includes a pair of opposing projections such as wings 180 having apertures 182 for fixed attachment to, e.g., a main part of a handheld device. The bracket cover 170 includes a pair of opposing projections such as ears 184 having apertures 186 for fixed attachment to, e.g., a flip part of a handheld device.

As shown in FIG. 16, the pin 154, preferably made of a metal such as alloy steel with plating, defines a rotational axis, which, when the hinge 150 is installed into a handheld device, preferably is generally perpendicular to the planes of the flip part and the main part. The pin 154 preferably has an opening 188 through which a cable harness or twisted flex cable may be inserted.

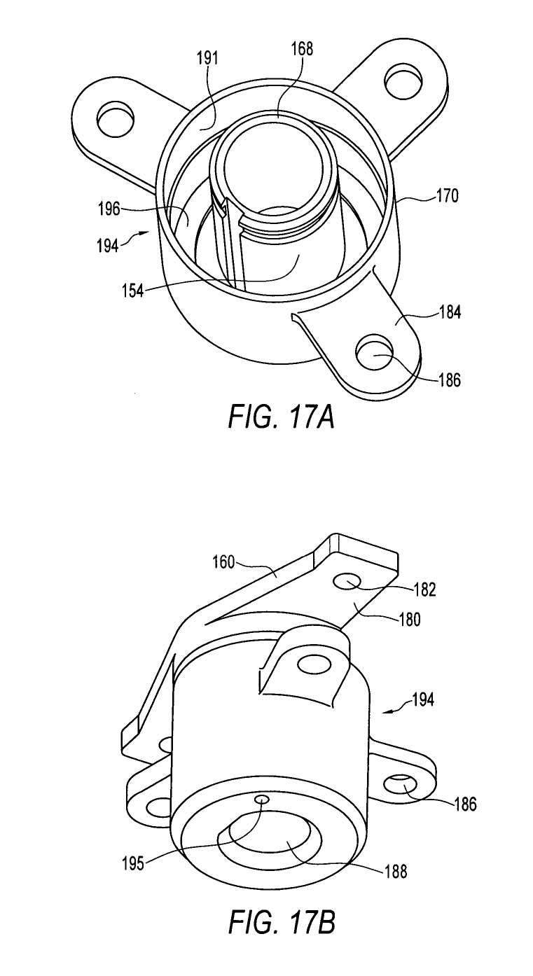

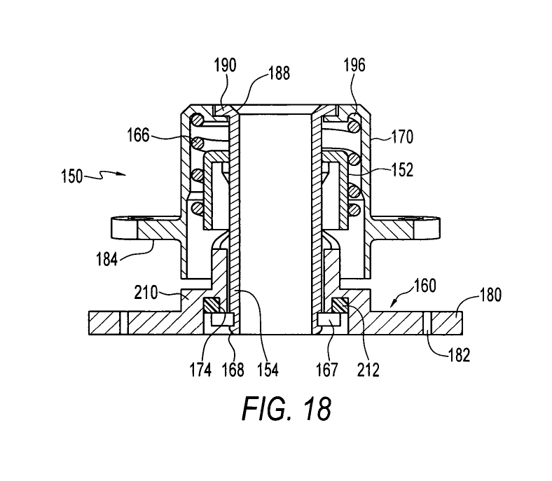

During assembly of the hinge 150, the pin 154 may be inserted into the bracket cover 170, until an oversized end 190 engages a seat 192 formed into the bracket cover. The pin 154 and the bracket cover 170 are rigidly connected so that they remain fixed with respect to one another. The bracket cover 170 includes a cylindrical wall 191 that radially surrounds the pin 154, the biasing member 166, and the follower 152, and encloses the majority of the hinge 150 (see FIG. 15). Preferably, the follower 152 and the bracket cover 170 are also made of a metal such as alloy steel with plating. In a preferred embodiment, the pin 154 and the bracket cover 170 are formed as a single-piece bracket cover/pin 194, as shown in FIGS. 17A-17B. The bracket cover/pin 194 may be formed from metal, similar to the separate pin 154 and bracket cover 170. An aperture 195 formed at an end of the bracket cover 170 or the bracket cover/pin 194 provides an opening for receiving an end, such as a post, of the biasing member 166. Because the bracket cover/pin 194 preferably is configured similarly to the combined pin 154 and bracket cover 170, though FIGS. 18-20B show the combined pin and bracket cover, it is contemplated that the bracket cover/pin may be substituted in the hinge 150.

As shown in FIGS. 18-19, the biasing member 166, preferably a coil spring with flat or round wire, is axially constrained between an inner surface 196 of the bracket cover 170 at one end, and at the other end by the follower 152 at both an engaging surface 198 and a surface 199 at the bottom of the stop rib 176. The inner surface 196 extends generally along a plane that is perpendicular to the rotational axis. The biasing member 166 surrounds a part of the follower 152 above the engaging surface (in the orientation shown in FIG. 18), and in turn surrounds the pin 154, biasing the follower lobes 156, 158 against the inner and outer cam tracks 162, 164.

To allow the follower 152 to remain rotationally fixed but axially slidable with respect to the pin 154, the follower includes one or more, but preferably a pair, of inwardly projecting ribs 200 (FIG. 20A), which slidingly engage grooves 202 on an outer surface of the pin. The ribs 200 and grooves 202 extend in a direction parallel to the rotational axis. Because the bracket cover 170 is fixed relative to the pin 154, the follower 152 cannot rotate within the bracket cover 170. Accordingly, rotation of the follower 152 with respect to the cam 160 results in rotation between the cam 160 and the bracket cover 170.

FIG. 16 shows an exemplary embodiment for the inner and outer cam tracks 162, 164. Preferably, the cam 160 also is made of plated alloy steel. As with the hinges 10 and 92, the inner and outer cam tracks 162, 164 preferably balance the biasing (e.g., spring) force from the biasing member 166. In a preferred embodiment, the inner and outer cam tracks 162, 164 have a cam profile providing an interface with the follower lobes 156, 158 such that the follower 152 can rotate in either a clockwise or counterclockwise direction, and such that a degree of initial resistance is provided in either direction from the biasing member 166 before the biasing member provides opening assistance for the hinge 150. Those of ordinary skill in the art will appreciate that other cam profiles may be used, and the present invention is not intended to be limited to a particular cam profile.

To prevent over-rotation of the follower 152 with respect to the cam 160 (e.g., at 180° in either direction), the sliding stop 172 rotates about the lower annular surface 174 of the cam 160. The lower annular surface 174 is disposed within a passage defined by a step 210 formed into the cam 160. A ring 212 that includes the stop 172 engages the lower annular surface 174, which provides a track for the ring that is concentric with the cam tracks 162, 164. The stop rib 176 (see FIG. 19) projects from the follower 152 in a direction parallel to the rotational axis and toward the cam 160. In other embodiments, instead of rotationally engaging the lower annular surface 174 of the cam 160, it is contemplated that the ring 212 may rotationally engage the pin 154 directly, for example in an area of the pin above the locking member 157 (as shown in FIGS. 16 and 18) and near the end 168. The inner annular surface 174 may be eliminated from the cam 160 in such exemplary embodiments.

In exemplary operation of the stop mechanism, as the follower 152 initially rotates, the stop rib 176 moves axially away from the cam due to the profile of the cam tracks 162, 164. As the follower continues to rotate, the stop rib 176 moves axially toward the cam 160, and as the stop rib rotates it engages the sliding stop 172 from one side, which is then urged to rotate along with the ring 212. When the sliding stop 172 encounters either surface 178 of the cam, the sliding stop, the stop rib 176, and thus the follower 152 are inhibited from further rotation. The sliding stop 172 and the ring 212 may, for example, be made of injection-molded acetal, or preferably steel.

To assemble the hinge 150, with the pin 154 engaged with the bracket cover 170 (or formed with the bracket cover), the biasing member 166 is inserted into the bracket cover, surrounding the pin. The follower 152 is also inserted into the bracket cover 170 and surrounding the pin 154, such that the ribs 200 are aligned with and engage the grooves 202 in the pin. The biasing member 166 is axially constrained by the inner surface 196 of the bracket cover 170 at one end, and both the engaging surface 198 and the surface 199 of the follower 152 at the other end. To attach the cam 160, the pin 154 then is placed through the cam, at which point the inner and outer follower lobes 156, 158 engage the inner and outer cam tracks 162, 164. The ring 212 with the stop 172 is placed around the surface 174 of the cam 160, so that the stop rib 176 can engage the stop.

To hold the cam axially, and thus retain assembly of the hinge 150, the locking member 167, such as an external lock ring preferably made of a metal such as carbon steel, is placed around the groove at the end 168 of the pin 154 and secured. The modular, assembled hinge 150 may then be inserted into a handheld device by mounting the bracket cover 170 to a main part or a flip part of the handheld device via the apertures 186, and by mounting the cam 160 to the other part of the handheld device via the apertures 182. Both the main part and the flip part typically have a plane extending generally perpendicular to the rotational axis, allowing for parallel plane rotation of the main part and the flip part.

In an exemplary operation, in which the cam tracks 162, 164 have a cam surface configured for initial resistance to rotation, the biasing member 166, positioned between the inner surface 196 of the bracket cover 170 and the engaging surface 198 of the follower, biases the follower against the cam 160. More particularly, the biasing member 166 biases the inner and outer follower lobes 156, 158 against the inner and outer cam tracks 162, 164.

When a user rotates the flip part of the handheld device with respect to the main part (or vice versa), the biasing member 166 provide initial resistance to rotation due to the configuration of the cam tracks 162, 164 shown in FIG. 16. Once a peak of either the inner or outer cam track 162, 164 is reached (depending on the direction of relative rotation), the follower lobes 156, 158 engage a downward cam track slope, and the biasing member 166 assists in rotation by biasing the follower lobes against the cam tracks. The follower 152 rotates with respect to the cam 160 as it axially slides with respect to the pin 154, and the rotationally fixed pin and bracket cover 170 rotate along with the follower, so that the cam rotates with respect to the pin. The part of the handheld device (main part or flip part) mounted to the bracket cover 170 rotates with respect to the part mounted to the cam 160, opening the handheld device. The inner and outer cam tracks 162, 164 provide a balanced operation.

In another embodiment, balanced operation is provided by aligning a pair of diametrically opposing outer engaging surfaces of a pin with a pair of diametrically opposed inner engaging surfaces of a follower. In an exemplary embodiment, a single cam track is used.

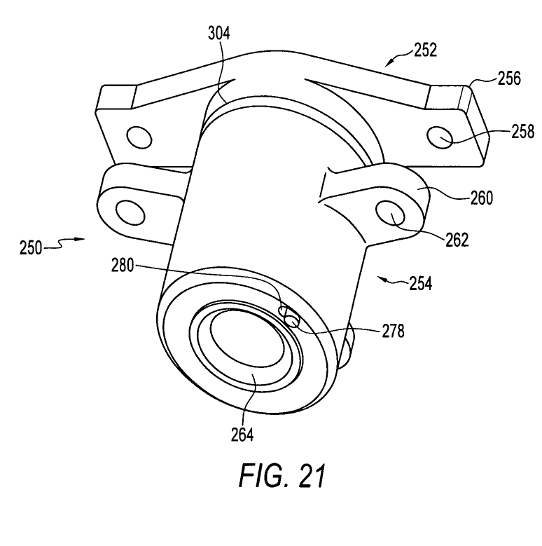

Referring now to FIGS. 21-25, a hinge 250 generally includes a cam 252 and a bracket cover 254 that rotate with respect to one another. As with the hinge 150, the cam 252 includes a pair of projections, such as wings 256 having apertures 258 for mounting to either a main part or a flip part of a handheld device. The bracket cover 254 includes a set of projections, such as ears 260 (e.g., three) having apertures 262 for mounting to the other part of the handheld device.

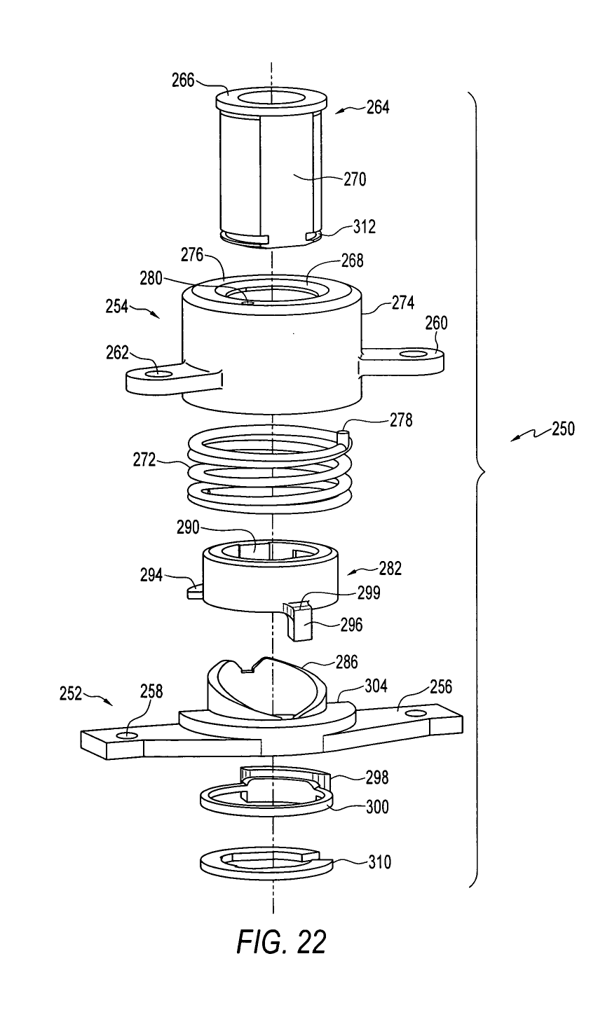

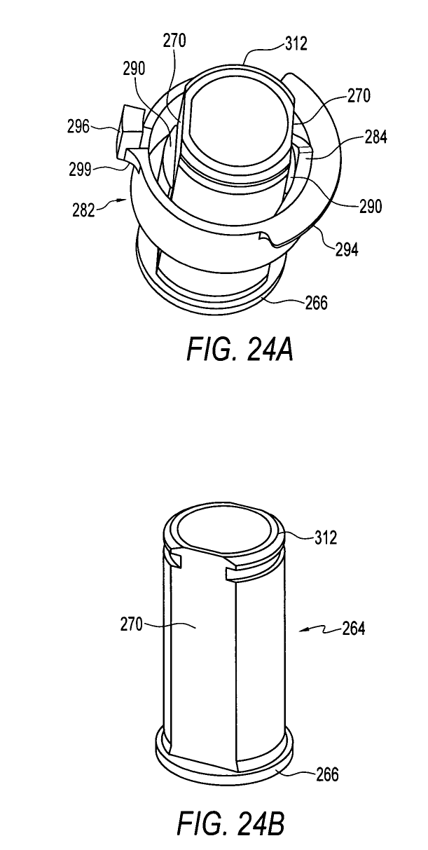

A pin 264 defining a rotational axis extends through the bracket cover 254 and the cam 252, and helps to retain the cam axially. As with the hinge 150, the bracket cover 254 and the pin 264 may be a single piece. Alternatively, as shown in FIGS. 21-23, the pin 264 may be inserted into the bracket cover 254 until an oversized end 266 of the pin engages a seat 268 of the bracket cover. As best seen in FIGS. 22 and 24A-24B, the exemplary pin 264 includes a pair of diametrically opposed outer engaging surfaces 270 (e.g., walls), which extend along a direction parallel to the rotational axis.

A biasing member 272, for example a wire spring, surrounds the pin 264 and is contained within a cylindrical wall 274 of the bracket cover 254. The biasing member 272 is axially constrained at one end by an inner surface 276 of the bracket cover 254, which inner surface extends perpendicularly to the rotational axis. In an exemplary embodiment, the biasing member 272 may include a post 278 at an end, which is inserted into an aperture 280 of the inner surface 276. This helps prevent rotation of the biasing member 272 within the bracket cover 254.

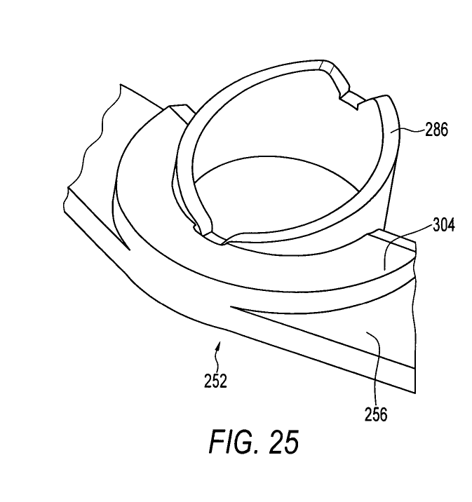

A follower 282 surrounds the pin 264 (e.g., see FIG. 24A) and includes a follower lobe 284 for engaging a cam track 286 (e.g., see FIG. 25) of the cam 252. As with the hinge 150, the biasing member 272 partially surrounds the follower 282 and biases the follower lobe 284 against the cam track 286. To rotationally fix the follower 282 with respect to the pin 264, a pair of diametrically opposed inner engaging surfaces 290 (e.g., walls) extend in a direction parallel to the rotational axis. The inner engaging surfaces 290 align with and slidingly engage the outer engaging surfaces 270 of the pin 264. Preferably, the surfaces 270, 290 are flat, while the remaining outer surfaces of the pin 264 are rounded. In this way, the follower 282 is axially slidable with respect to the pin 264, but is rotationally fixed. It is contemplated that other configurations for the surfaces 270, 290 are possible, provided that the surfaces allow the follower 282 to axially slide with respect to the pin 264, without allowing relative rotation. For example, the outer engaging surfaces may instead be axially extending grooves similar to the groove 202 in the pin 154, and the inner engaging surfaces may instead be axially extending ribs such as ribs 200 in the follower 152. As another alternative, the outer engaging surfaces may include one flat surface and one groove, and the inner engaging surfaces may include an engaging flat surface and an inner rib.

Because the preferred pairs of surfaces 270, 290 are diametrically opposed, the biasing force (e.g., spring force) provided by the biasing member 272 is balanced. The area of the surfaces 270, 290 may vary, provided that the area is sufficient to rotationally fix the follower 282 with respect to the pin 264.

Assembly of the hinge 250 is similar to that for the hinge 150. Particularly, the pin 264 is inserted into the bracket cover 254 (unless the pin and bracket cover are a single piece), and the biasing member 272 and then the follower 282 are placed around the pin. The pin 264 and bracket cover 254 are fixed with respect to one another. Preferably, the biasing member 272 is positioned so that the post 278 engages the aperture 280 on the bracket cover 254. When inserting the follower 282, the inner engaging surfaces 290 of the follower are aligned with the outer engaging surfaces 270 of the pin 264. The follower 282 includes an engaging surface 294 perpendicular to the rotational axis for engaging the biasing member (similar to the surface 198 of the follower 152), and further includes a stop rib 296 (similar to stop rib 176) for engaging a stop 298. A surface 299 at the bottom of the stop rib 296 axially constrains the biasing member 272, similarly to surface 199 of follower 152. The stop 298 is similar to the stop 172, and includes a ring 300 for rotational movement around an annular surface 302 within the cam 252. The annular surface 302 preferably is within a passage created by providing a step 304 for the cam 252 (as with the cam 160 (see FIG. 16)).

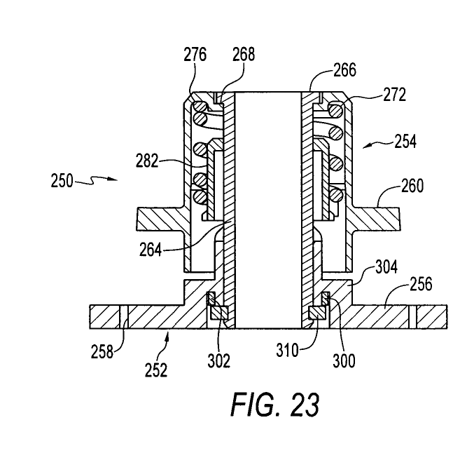

The cam 252 then is placed so that the cam track 286 engages the follower lobe 284, and the stop 298 is attached by placing the ring 300 about the annular surface 302. A locking member 310, preferably similar to locking member 166, is then placed in a groove around an end 312 of the pin 264. The locking member 310 retains the cam 252 axially, and thus retains assembly of the hinge 250. As with the hinge 150, it is contemplated that, instead of engaging the annular surface 302, the ring 300 may directly rotationally engage a surface of the pin 264 near the end 312 and axially above (in the orientation shown in FIG. 23) the locking member 310.

Operation of the hinge 250 in exemplary embodiments also is similar to that of the hinge 150. The exemplary cam track 286 shown permits rotation in either the clockwise or counterclockwise direction, and provides initial resistance to opening the hinge 250 in either direction. A more balanced biasing force is provided by engagement of the aligned engaging surfaces 270, 290, instead of improving balance by using both inner and outer cam tracks. By reducing the number of cam tracks, the diameter of the cam 252 and thus the diameter of the exemplary hinge 250 can be reduced. Preferably, the materials used for the pin 264, the bracket cover 254, the biasing member 272, the follower 282, the cam 252, the stop 298, and the locking member 310 are similar to that used for analogous parts of the hinge 150.

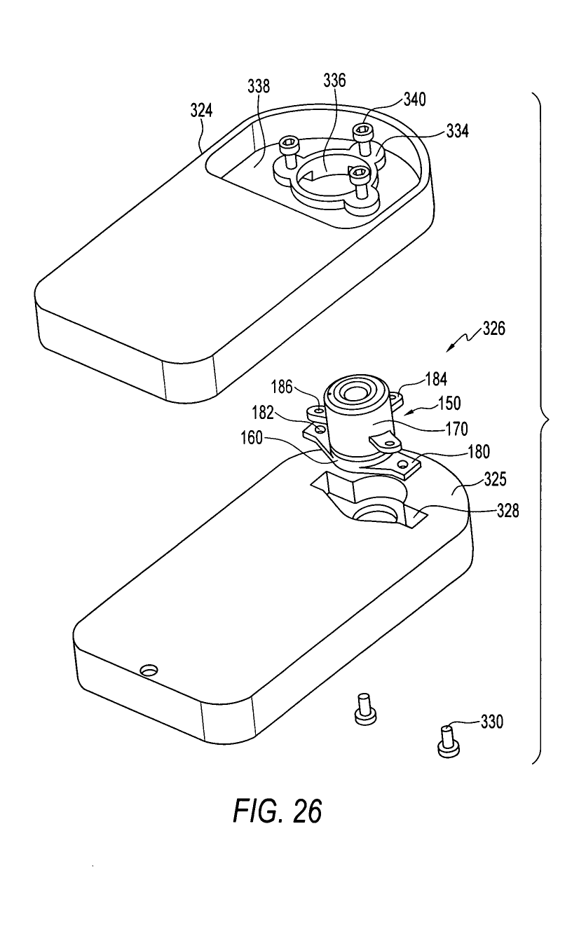

As shown in FIG. 26, either of the hinges 150 and 250 can be mounted respectively to a main part 325 and a flip part 324 of a handheld device 326 for providing rotation between the main part and the flip part. For example, the cam 160 of hinge 150 may be mounted to the main part 325 by inserting the cam into a seat 328 in the main part and inserting fasteners 330 such as a pair of M2×5 screws through the apertures 182 formed in wings 180.

To mount the hinge 150 to the flip part 324, a seat 334 may be provided for accommodating the ears 184, and an opening 336 may be provided for inserting the cylindrical bracket cover 170 that is above the ears through the opening. By providing the seat 334 in a lower area 338 of the flip part 324, the bracket cover 170 preferably can be accommodated substantially or entirely within the height of the flip part. Fasteners 340 such as three M2×5 screws may be inserted through the apertures 186 of the ears 184 for mounting the bracket cover 170. In this way, rotation of the bracket cover 170 with respect to the cam 160 in turn rotates the flip part 324 with respect to the main part 326.

Example information about opening angles as well as materials for preferred embodiments is presented herein for illustrating preferred embodiments but is not intended to limit the invention in its broader aspects. However, the angles and/or materials described herein may be especially well-suited for portable devices such as handsets, and particularly cell phones.

While specific embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the present invention are set forth in the appended claims.

What is claimed is:

1. A parallel plane rotation hinge for a portable device comprising:
a pin defining a rotational axis;
a cam having an inner cam track and an outer cam track;
a follower surrounding said pin and being rotationally fixed and axially slidable with respect to said pin, said follower including inner and outer follower lobes for respectively rotationally engaging the inner and outer cam tracks;
a biasing member disposed about said pin to bias said bushing against said cam.

2. The hinge of claim 1 wherein said cam is disposed about said pin, and further comprising:
a locking member for engaging an end of said pin to hold said cam axially.

3. The hinge of claim 1 further comprising:
a track fixed relative to said cam and extending along a direction concentric with the inner cam track and the outer cam track, the track being defined between opposing inner surfaces;
a stop slidable along said track and disposed within a rotational path of a part of said follower such that the part of said follower engages said stop during relative rotation of said follower, and such that further relative rotation of the part of said follower slides said stop until said stop engages one of the opposing inner surfaces.

4. The hinge of claim 1 wherein an interface between the inner and outer cam tracks and the inner and outer follower lobes respectively define a bias position resisting initial relative rotation of said follower.

5. The hinge of claim 1 wherein the interface between the inner and outer cam tracks and the inner and outer follower lobes provide a closed position for the hinge that initially resists initial movement, but allows rotation of said follower with respect to said cam in both clockwise and counterclockwise directions.

6. The hinge of claim 1 wherein said pin comprises at least one groove extending parallel to the rotational axis, and wherein said follower comprises at least one inwardly projecting rib slidingly engaging the at least one groove.

7. The hinge of claim 1 further comprising:
a bracket cover comprising a cylindrical wall disposed radially outside of said pin, said biasing member, and said follower, said bracket cover further comprising an inner surface extending perpendicular to the rotational axis, wherein said biasing member is disposed between the inner surface and a surface of said follower.

8. The hinge of claim 7 wherein said pin and said bracket cover are a single piece.

9. The hinge of claim 7 wherein said bracket cover comprises at least one engaging member for fixedly engaging a first part of a handheld device, and wherein said cam comprises at least one engaging member for fixedly engaging a second part of the handheld device that is rotationally movable with respect to the first part.

10. The hinge of claim 9 wherein the first part and the second part of the handheld device each extends generally along a plane perpendicular to the rotational axis.

11. A parallel plane rotation hinge for a portable device comprising:
a pin defining a rotational axis and comprising a pair of diametrically opposed outer surfaces extending parallel to the rotational axis;
a cam having a cam track;
a follower surrounding said pin, said follower comprising a pair of diametrically opposed inner surfaces extending parallel to the rotational axis and slidingly engaging the pair of outer surfaces, wherein said follower is rotationally fixed and axially slidable with respect to said pin, said follower including at least one follower lobe for rotationally engaging the cam track;
a biasing member disposed about said pin to bias said bushing against said cam.

12. The hinge of claim 11 wherein said pair of outer surfaces each comprises a substantially flat surface.

13. The hinge of claim 12 wherein said pair of inner surfaces each comprises a substantially flat surface.

14. The hinge of claim 11 wherein said cam is disposed about said pin, and further comprising:
a locking member for engaging an end of said pin to hold said cam axially.

15. The hinge of claim 11 further comprising:
a track fixed relative to said cam and extending along a direction concentric with the cam track, the track being defined between opposing inner surfaces;
a stop slidable along said track and disposed within a rotational path of a part of said follower such that the part of said follower engages said stop during relative rotation of said follower, and such that further relative rotation of the part of said follower slides said stop until said stop engages one of the opposing inner surfaces.

16. The hinge of claim 11 further comprising:
a bracket cover comprising a cylindrical wall disposed radially outside of said pin, said biasing member, and said follower, said bracket cover further comprising an inner surface extending perpendicular to the rotational axis, wherein said biasing member is disposed between the inner surface and a surface of said follower.

17. The hinge of claim 16 wherein said pin and said bracket cover are a single piece.

18. The hinge of claim 16 wherein said bracket cover comprises at least one engaging member for fixedly engaging a first part of a handheld device, and wherein said cam comprises at least one engaging member for fixedly engaging a second part of the handheld device that is rotationally movable with respect to the first part.

19. The hinge of claim 18 wherein the first part and the second part of the handheld device each extends generally along a plane perpendicular to the rotational axis.

20. A parallel plane rotation hinge for a portable device comprising:
a follower;
cam means for providing balanced relative rotation with said follower;
means for axially engaging said follower with said cam means.
